(19) United States
(12) Patent Application Publication
(10) Pub. No.: US 2008/0150706 A1
(43) Pub. Date: Jun. 26, 2008

(54) Vehicle mounted information display system

(75) Inventor: James Richard Weber, Lacon, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/643,832

(22) Filed: Dec. 22, 2006

(51) Int. Cl. H04Q 1/00

(52) U.S. Cl. 340/425.5

(57) ABSTRACT

An information system for a mobile vehicle is disclosed. The information system may have at least one display mounted to the mobile vehicle for viewing outside of the mobile vehicle. The information system may also have a controller in communication with the at least one display. The controller may be configured to send vehicle information to the at least one display.

### TECHNICAL FIELD

The present disclosure is directed to an information display system and, more particularly, to an information display system mounted externally to a mobile vehicle.

### BACKGROUND

Information has been communicated to the public in many different ways including, among other things, through the use of radio, television, telephone, email, billboards, flyers, brochures, and other ways. For years, the targeting of specific communications to particular viewers has been used as an effective tool for marketing, public announcements, safety purposes, alerts, and other intents. The more specific the information that reaches targeted individuals, the greater the likelihood of success in fulfilling the communicated purpose. With this in mind, moving billboards that are strategically located have recently been recognized as one way to communicate specific information to a large population of targeted viewers.

One implementation of the moving billboard strategy is disclosed in U.S. Pat. No. 6,701,143 (the '143 patent) issued to Dukach et al., on Mar. 2, 2004. Specifically, the '143 patent discloses a mobile unit such as a taxi, bus, train, truck, or passenger vehicle having one or more displays visible from outside of the unit. The mobile unit is in wireless communication with a central system to receive display information as a function of the unit's location. That is, the mobile unit repeatedly transmits a locator signal to and receives display selection messages from the central system. The central system determines a zone in which the mobile unit is located, selects a display to be shown by the mobile unit based on the zone, and transmits a display selection message to the unit identifying a selected display message to be shown on the mobile unit's display. The display message may include advertisements, weather, traffic reports (including local traffic reports, such as reports of how many feet till the scene of a traffic jam or a detour), news, public service announcements, and information and entertainment programming.

Although the display system of the '143 patent may adequately transmit some information to the public in a targeted manner, it may be limited. That is, the system of the '143 patent provides no operational or specific information associated with the mobile unit or intent of the unit's driver. As the size of the display and, more particularly, the size of the mobile unit increases, it may be advantageous to provide this information to other drivers in the vicinity of the mobile unit. For example, if the mobile unit is a long tractor-trailer combination operating on a narrow dual-highway at low speeds, a vehicle behind the combination may desire to pass the slower moving tractor-trailer. However, if it was known that the tractor-trailer was abnormally long and would be exiting the highway within a quarter mile of the current location, the vehicle's driver may, instead, choose to endure the slower speeds without passing. The system of the '143 patent does not accommodate this need.

The display system of the present disclosure solves one or more of the problems set forth above.

### SUMMARY OF THE INVENTION

One aspect of the present disclosure is directed to an information system for a mobile vehicle. The information system may include at least one display mounted to the mobile vehicle for viewing outside of the mobile vehicle. The information system may also include a controller in communication with the at least one display. The controller may be configured to send vehicle information to the at least one display.

Another aspect of the present disclosure is directed to a method of providing information. The method may include receiving vehicle information. The method may also include displaying the vehicle information from a mobile vehicle for viewing offboard the mobile vehicle.

### BRIEF DESCRIPTION OF THE DRAWINGS

FIG. 1 is a pictorial illustration of an exemplary disclosed display system;

FIG. 2 is a diagrammatic depiction of an exemplary disclosed machine for use with the display system of FIG. 1; and

FIG. 3 is a diagrammatic depiction of an exemplary disclosed display system for use with the display system of FIG. 1.

### DETAILED DESCRIPTION

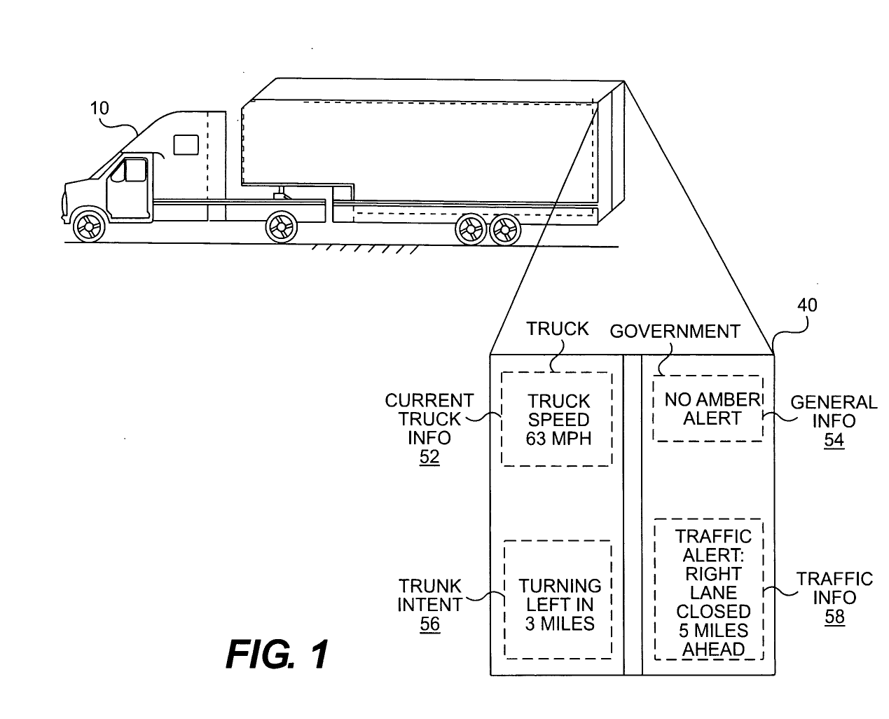

FIG. 1 illustrates an exemplary machine 10. Machine 10 may be a mobile machine that performs some type of operation associated with an industry such as transportation, construction, farming, or any other industry known in the art. For example, machine 10 may be an on-highway vocational vehicle or tractor-trailer combination. Machine 10 may include among other things, a power source 20, a traction device 30, and a display system 40. Machine 10 may further include a drive train to propel the machine 10 and a body supported by the drive train.

Power source 20 may be an engine such as, for example, a diesel engine, a gasoline engine, a natural gas engine, or any other engine known in the art. Power source 18 may also be another source of power such as a fuel cell, a power storage device, or another source of power known in the art. Power source 20 may be adapted to drive traction device 30.

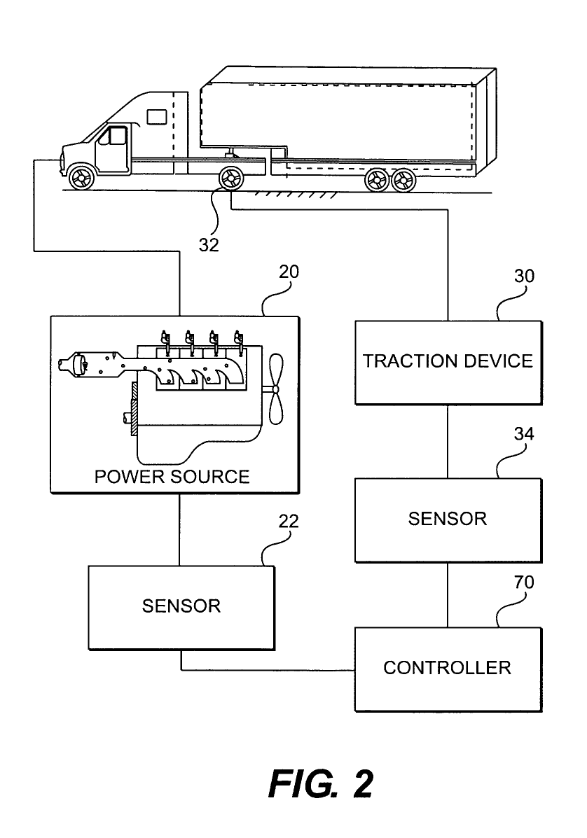

As illustrated in FIG. 2, one or more sensors 22 may be associated with power source 20 to detect operational parameters of power source 20. For example, sensors 22 may detect among other things, engine speed, engine temperatures, RPM, fuel consumption rate, and remaining fuel. Sensors 22 may be in communication with a controller 70 to transmit the collected data via a wired or wireless connection.

Traction device 30 may include one or more wheels 32 located on each side of machine 10 (only one side shown) and driven by power source 20. Traction device 30 may include a differential gear assembly (not shown) to divide power from power source 20 between wheels 32 located on either side of machine 10. Alternately, traction device 30 may include tracks, belts, or other traction devices. Some of wheels 32 may be rotatable about a vertical axis for use during steering.

One or more sensors 34 may be associated with traction device 30 to detect parameters of traction device 30 and its operation. For example, sensors 34 may detect current vehicle speed, acceleration, deceleration, torque, or even road conditions, such as slippery pavement, loose gravel, or inclination. Sensors 34 may be in electronic communication with controller 70 to transmit the collected data via a wired or wireless connection.

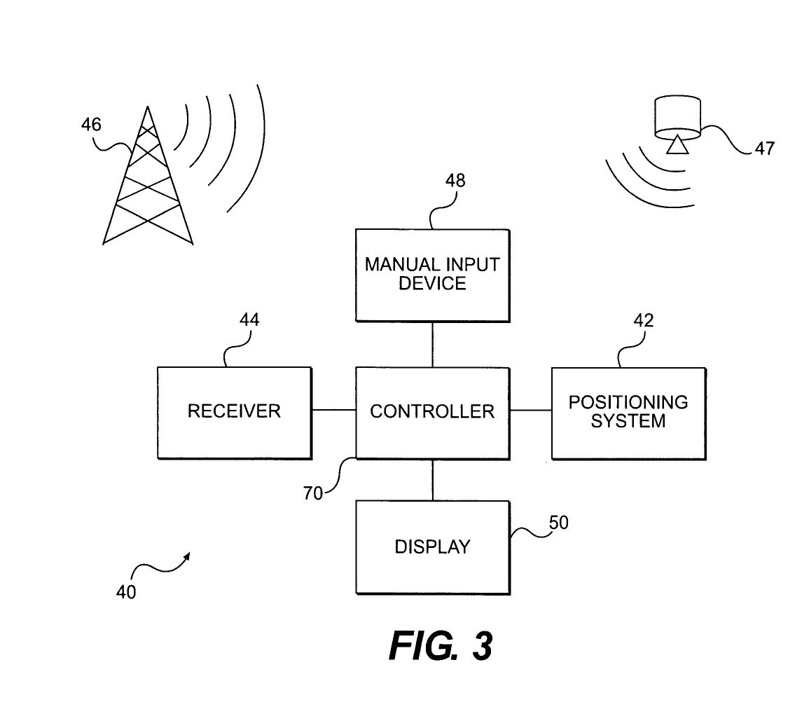

As illustrated in FIG. 3, display system 40 may include a positioning system 42, transmitter 46, receiver 44, manual input device 48, display 50, and controller 70. Controller 70 may receive various inputs from positioning system 42, transmitter 46 via receiver 44, and manual input device 48. In response to these inputs, controller 70 may display corresponding information on display 50.

Positioning system 42 may utilize global positioning technology, a local coordinate system, a radio frequency transmitter, or any other system capable of determining a proximate location of machine. Positioning system 42 may be in electronic communication with the controller 70 and capable of outputting the current location of machine 10 in longitudinal and latitudinal coordinates, a zip code, city and town, or any other nomenclature capable of communicating a proximate location of machine 10.

Transmitter 46 may communicate information to machine 10 from a remote location. This transmitter 46 may be a satellite, radio tower, cellular network, or any other transmitter known in the art capable of wirelessly transmitting data. The transmitter 46 may be operated by a private company, for example, the company operating machine 10. It is also contemplated that transmitter 46 may be operated by a city, state, or federal government for the purpose of disseminating specific knowledge and information. For example, the transmitter 46 may broadcast information pertaining to the general location of machine 10, such as local traffic conditions, weather conditions and forecasts, Amber alerts, or any other information that may be beneficial to the public.

Receiver 44 may receive information broadcast from transmitter 46. Receiver 44 may comprise a radio antenna, cellular antenna, or any other device capable of receiving a data signal from transmitter 46. Once receiver 44 receives the information, the information may be transmitted to controller 70 via a wired or wireless communication means.

Manual input device 48 may enable an operator of machine 10 to enter information not otherwise provided via the sensors 22, 34, positioning system 42, or transmitter 46. Manual input device 48 may comprise a keyboard, mouse, touch screen, voice recognition software, or any other input device known in the art to allow an operator to manually input information to controller 70 for display with display system 40. Information may include an intended destination, statistical information, or any other information the operator may wish to communicate via the display system 40. For example, the operator may input an address corresponding to an intended delivery location, a change in a predetermined travel path, or information relating to the load on machine 10, such as “Hazardous Waste” or “Radioactive”.

Display 50 may be oriented on machine 10 according to the type of information to be displayed. For example, as depicted in FIG. 1, display 50 may be oriented on the back of a machine 10 to give information to people behind the machine 10. It is also contemplated that display 50 may be oriented in other locations to provide directed information to various persons. For example, display 50 may be oriented on the side of machine 10 to provide information to pedestrians. In another embodiment, display 50 may be oriented toward the front of machine 10, facing forward to provide information to oncoming traffic.

Display 50 may comprise one or more cathode ray tubes (CRT's), liquid crystal displays (LCD), plasma displays, or another device that is capable of displaying graphics and/or text. Display 50 may display information provided to the controller 70 by sensors 22 and 34, manual input device 48, positioning system 42, and/or receiver 44.

In one specific embodiment, display 50 may include a truck information display 52, a public announcement display 54, a navigational intent display 56, a traffic display 58, and any other display necessary to communicate information to the surrounding vehicles. The different displays 52, 54, 56, 58 may be configured to display different types of information, and may further be mounted in a location relevant to the type of information displayed. For example, the truck information display 52 may be mounted near the top left of the back planar surface of machine 10 to inform vehicles passing on the left of the speed of machine 10. Further, the public announcement display 54 may be mounted near the top right of the back planar surface of machine 10 to enable the information displayed to be viewable by a maximum number of following vehicles. Still further, the navigational intent display 56 may be mounted near the bottom left of the back planar surface of machine 10 to inform vehicles immediately following machine 10 of any upcoming or imminent changes in travel path. Still further, the traffic information display 58 may be mounted near the bottom right of the back planar surface of machine 10 enable vehicles immediately following the machine 10 to view information relating to upcoming traffic and road conditions. Among other reasons, this may be advantageous where the machine 10 is a large tractor-trailer which blocks the vehicles following from having visual access to various signs mounted either overhead or roadside.

Controller 70 may be in communication with positioning system 42, receiver 44, transmitter 46, manual input device 48, and display 50. Controller 70 may receive various inputs from positioning system 42, transmitter 46 via receiver 44, and manual input device 48. In response to these inputs, controller 70 may display corresponding information on display 50.

Controller 70 may include any means for monitoring, recording, storing, indexing, processing, and/or communicating the operational aspects and parameters of machine 10. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

Controller 70 may store statistics relevant to the individual machine 10. These vehicle statistics may include the length, width, and height of the vehicle, gross weight, number of wheels, number of trailers, operators name and biographical information and any other information relevant to the identification and operation of machine 10. The statistics may change depending on the type of load, trailer, or task and/or may be input manually by operator. The statistical information may also be provided via manual input device 48 or transmitter 56 at the start of a transport event of machine 10.

Controller 70 may also store parameters relating to the sensed operation of machine 10 and power source 20. These parameters may include vehicle speed, engine temperature, torque, and any other information relevant to the current operating characteristics of machine 10 and power source. Parameters may come directly from sensors 22 and 34 or be estimated based on sensed values.

Controller 70 may also store geographic information relating to the past, current and future navigational course of machine 10. This geographic data may include origin of trip, destination, next change of course, current location, interruption of course, and any other geographic information relating to the operation of machine 10. The geographic data may be provided to the controller 70 via positioning system 42 or manual input device 48.

Controller 70 may also store information on current detectable road conditions. These detectable road conditions may include low traction conditions due to wet or icy roads, loose gravel, rough pavement, steep inclines and declines, and any other road condition relevant to the operation of machine 10. The detectable road conditions may be determined by sensors 34. For example, the controller 70 may determine wheel slip when the rotation speed of wheels 32 exceed the current travel speed or mean rotation speed.

Controller 70 may also store information unrelated to the specific operation of machine 10. This information may be provided via transmitter 46, manual input device 48, or any other device capable of providing such information to controller. The information may include, among other things, weather, news, Amber Alerts, public announcements, advertisements, or any other information provided to be displayed on display of machine 10. The information may be determined via transmitter 46, preprogrammed into controller 70, or input via manual input device 48 by the operator.

In the course of machine operation, the information stored in controller 70 may change. This change in information stored in and/or provided to controller 70 may be affected by a change in the location of machine 10, time of day, weather conditions, road conditions, or any other condition that may require a change of information. Controller 70 may send updated information to display 50 in predetermined timed intervals, in response to a request via manual input device 48 or transmitter 46, in response to sensed information, or any other available means for determining the frequency and timing of sending information to display 50.

### INDUSTRIAL APPLICABILITY

The disclosed display system 40 finds potential application in any machine 10 where it is desirous to provide vehicle information to persons external to the machine 10. The display system 40 is particularly advantageous in a machine 10 where the display system 40 constitutes a condition of allowing the machine 10 to operate, such as where government regulations require the use the disclosed display system in exchange for licensing larger transportation machines. The operation of the display system 40 will now be explained.

Referring to FIG. 1, at any time during the execution of a given task, it may be beneficial for the machine 10 to provide information to neighboring vehicles and pedestrians via its display system 40. The information communicated by display system 40 may be collected and stored by controller 70 from various sources, including the positioning system 42, the receiver 44, the power source sensors 22, the traction device sensors 34, and a manual input device 48.

To illustrate the operation of the disclosed display system 40, a few situational examples will now be proposed.

In a first exemplary embodiment of the disclosed display system 40, machine 10 may be traveling on a highway substantially surrounded by other vehicles. Display 50 may be oriented on the back planar surface of a machine 10 such that persons traveling substantially behind the machine 10 and following in a similar direction may be able to observe the information it provides.

In one exemplary embodiment, it may be appropriate to display information regarding the current parameters of the machine 10 on truck information display 52. For example, it may be beneficial to display a current speed of the machine 10 to enable observers to compensate and/or plan driving maneuvers accordingly. Sensor 34 may detect the current speed from traction device 30 and transmit the current speed to controller 70. Once controller 70 receives a current speed from sensor 34, it may cause display 50 to show the current speed in a manner understandable by the neighboring vehicles, including textual display of Arabic numerals, graphical depiction of a speedometer, or any other method capable of communicating such information. Further, it may also be beneficial to display a length of the machine 10 to assist surrounding vehicles in various driving tasks, such as passing or merging. The operator may input such information via manual input device 48. Controller 70 may then cause display 50 to show the length of the machine 10 in a manner understandable by the neighboring vehicles, including textual display of Arabic numerals, graphical depiction of the work vehicle, or any other method capable of communicating such information.

In another exemplary embodiment, it may be appropriate to display information regarding the future intent of the machine 10 on navigational intent display 56. For example, it may be beneficial to display an upcoming navigational change, such as an upcoming left turn, a stop, a deceleration, or any other change, to enable observers to prepare and compensate accordingly. The operator of machine 10 may input the destination data of the machine 10 via manual input device 48 and positioning system 42 may provide position data to controller 70, such as the current location of the machine 10. Controller 70 may then determine a best available route for the machine 10 to follow to reach the destination in an efficient manner. For example, controller 70 may utilize the destination data, position data and a mapping software stored in its memory to determine the route data. Once the controller 70 determines the route data, it may use the current position data to determine the next navigational event, such as the upcoming left turn. Once the controller 70 determines the next navigational event, it may cause display 50 to display the navigational event in a manner understandable by neighboring vehicles, including text (“Turning Left in Three Miles”), graphical depictions of a change in direction (arrows), or any other method capable of communicating such information. Operator may also input deviations from the preplanned route via manual input device 48.

In another exemplary embodiment, it may be appropriate to display information regarding the current and expected traffic conditions on traffic display 58. For example, it may be beneficial to display upcoming traffic changes, road closings, or any other traffic-affecting condition received via transmitter 46 or input by the operator via manual input device 48. Positioning system 42 may provide position data to controller 70, such as the current location of the machine 10. Further, transmitter 46 or satellite 47 may broadcast traffic data containing both a proximate location and a specified condition. Using both the position data and the traffic data, controller 70 may determine the next traffic condition to be encountered by machine 10 and cause display 50 to display the traffic condition in a manner understandable by the neighboring vehicles. For example, the display may state “Traffic Alert: Right Lane Closed 5 Miles Ahead” to alert surrounding vehicles to an upcoming lane closing, or any other informational statement that may be beneficial to nearby vehicles. It is also contemplated that traffic display 58 may receive a photographic or video feed from a camera (not shown) mounted on machine 10. Displaying such a feed on traffic display 58 may provide surrounding vehicles or pedestrians views of the road otherwise unattainable. For example, a forward mounted video camera mounted in or near the operator of machine 10 may provide to traffic display 58 a current view of the road and traffic conditions ahead as seen from the operator's perspective.

In yet another exemplary embodiment, it may be appropriate to display general public safety information to the surrounding vehicles on public announcement display 54. For example, it may be beneficial to display an “Amber alert”, alerting passengers to a child missing from a nearby community. Transmitter 46 may broadcast safety data containing both a proximate location and a specified alert. For example, transmitter 46 may broadcast an “Amber alert” containing both a proximate location (i.e., a fifty mile radius from a given location) and a specified alert (i.e., “Amber Alert—Child Missing”). Receiver 44 may receive the broadcast and compare the proximate location included within the safety data to position data obtained via positioning system 42. Based on this comparison, controller 70 may determine that machine 10 is within the proximate location and may cause display 50 to display the specified alert in a manner understandable by the neighboring vehicles.

The present disclosure may allow a machine 10 to transmit multiple types of information to the public. It may provide operational statistics or information associated with the machine 10 or the intent of the operator. This may be advantageous because it may allow other drivers in the vicinity of the machine 10 to plan accordingly in view of upcoming traffic conditions, road conditions, navigation changes of machine 10, or any other information provided to the drivers via the display system 40. Providing this information to the public may increase the safety and awareness of surrounding vehicles, and may increase their ability to safely plan and compensate for future road conditions that may require corrective action.

It will be apparent to those skilled in the art that various modifications and variations can be made to the display system 40 of the present disclosure. Other embodiments of the display system 40 will be apparent to those skilled in the art from consideration of the specification and practice of the display system 40 disclosed herein. It is intended that the specification and examples be considered as exemplary only, with a true scope being indicated by the following claims and their equivalents.

What is claimed is:

1. An information system for a mobile vehicle, comprising:
at least one display mounted to the mobile vehicle for viewing outside of the mobile vehicle; and
a controller in communication with the at least one display and configured to send vehicle information to the at least one display.

2. The information system of claim 1, wherein the vehicle information includes statistical information.

3. The information system of claim 2, wherein the statistical information includes a length of the mobile vehicle.

4. The information system of claim 1, further including at least one sensing device configured to sense an operational parameter of the mobile vehicle, wherein the vehicle information is associated with the operational parameter.

5. The information system of claim 4, wherein the operational parameter is related to a travel speed of the mobile machine.

6. The information system of claim 4, wherein the operational parameter is related to a road condition.

7. The information system of claim 1, further including an operator input device, wherein the vehicle information is associated with a driving intent of the mobile vehicle's operator.

8. The information system of claim 7, wherein the driving intent includes a known change in travel course input by the operator.

9. The information system of claim 1, further including a locator disposed on the mobile vehicle to determine a location of the mobile vehicle, wherein the vehicle information varies in response to the determination.

10. The information system of claim 1, further including a receiver disposed onboard the mobile vehicle to remotely receive information for display.

11. The information system of claim 1, wherein the at least one display includes a first display and a second display, each of the first and second displays being configured to receive different types of information from the controller.

12. The information system of claim 11, wherein the mounting location of the first and second displays is related to the types of information.

13. A method of providing information offboard a mobile vehicle, the method comprising:
receiving vehicle information; and
displaying from the mobile vehicle the vehicle information for viewing offboard the mobile vehicle.

14. The method of claim 13, wherein the vehicle information includes statistical information received at the start of a transport event.

15. The method of claim 13, further including sensing an operational parameter of the mobile vehicle, wherein the vehicle information is associated with the operational parameter.

16. The method of claim 13, wherein the vehicle information further includes an intended deviation from a current course of travel.

17. The method of claim 13, further including determining a location of the mobile vehicle, wherein the information varies in response to the determination.

18. The method of claim 13, wherein the information is received remotely from offboard the mobile vehicle.

19. The method of claim 13, further including categorizing the information and displaying the information from different locations onboard the mobile vehicle in response to the categorization.

20. A mobile vehicle, comprising:
a drive train configured to propel the mobile vehicle;
a body supported by the drive train;
at least one display mounted to the body for viewing offboard the mobile vehicle;
a locating device disposed onboard the mobile vehicle to determine a location of the mobile machine;
an operator input device configured to receive an intent to deviate from a current course of travel;
a receiver disposed onboard the mobile vehicle to remotely receive information for display; and
a controller in communication with the at least one display, the operator input device, and the receiver, the controller being configured to send vehicle information to the at least one display, wherein the vehicle information includes at least one of statistical information, information associated with an operational parameter of the mobile vehicle, a sensed road condition, and a deviation intent of the operator.
